(19) United States
(12) Patent Application Publication
(10) Pub. No.: US 2024/0009771 A1
(43) Pub. Date: Jan. 11, 2024

(54) Method for Producing an Object Layer by Layer

(71) Applicant: Siemens Aktiengesellschaft, München (DE)

(72) Inventors: Frank Heinrichsdorff, Teltow (DE); Darya Kastsian, Falkensee (DE); Daniel Reznik, Berlin (DE)

(73) Assignee: Siemens Aktiengesellschaft, München (DE)

(21) Appl. No.: 18/254,289

(22) PCT Filed: Nov. 5, 2021
(86) PCT No.: PCT/EP2021/080750

§ 371 Date: May 24, 2023

(30) Foreign Application Priority Data
Nov. 26, 2020 (EP) 20210014.5

(51) Int. Cl. B23K 26/342; B22F 10/28; B33Y 10/00

(52) U.S. Cl. CPC B23K 26/342; B22F 10/28; B33Y 10/00

(57) ABSTRACT

Various embodiments of the teachings herein include methods for producing an object layer-by-layer using a powder-based 3D printing method by selective fusing of layers of a powder in a powder bed with a selective laser melting process or selective electron beam melting process. At least two successive layers are part of a group. An example method includes, for each group: providing a first layer of the powder; fusing a part of the first layer with first exposure vectors parallel to one another and at a defined spacing; providing a second layer of powder; and fusing a part of the second layer with second exposure vectors arranged at an offset parallel to the first exposure vectors. The exposure vectors of successive groups are rotated by an angle relative to one another.

### CROSS-REFERENCE TO RELATED APPLICATIONS

This application is a U.S. National Stage Application of International Application No. PCT/EP2021/080750 filed Nov. 5, 2021, which designates the United States of America, and claims priority to EP Application No. 20210014.5 filed Nov. 26, 2020, the contents of which are hereby incorporated by reference in their entirety.

### TECHNICAL FIELD

The present disclosure relates to manufacturing. Some embodiments of the teachings herein include systems and/or methods for producing an object layer-by-layer using a powder-based 3D printing method.

### BACKGROUND

Some powder-based 3D printing processes include selective laser melting process (SLM) or a selective electron beam melting process (EBM). It has been found that hitherto favored procedures can produce many local overheats. These overheats can produce larger metal beads, which significantly interfere with the further powder layering process. The quality of the components achieved is thus significantly reduced or the construction process may even be interrupted.

### SUMMARY

The teachings of the present disclosure may allow 3D printing methods which avoid local overheating in selective, powder-based 3D printing processes, in particular melting processes. For example, some embodiments include a method for producing an object layer by layer using a powder-based 3D printing method by selective fusing of layers (n, n+1, n+2) of a powder in a powder bed (100) by means of a selective laser melting process or selective electron beam melting process, wherein at least two successive layers (n, n+1, n+2) are part of a group (G1, G2) in each case, the method comprising the following for each of the groups (G1, G2): providing a first layer (n) of the powder, fusing at least one part of the first layer (n) with first exposure vectors (Vn), which are arranged parallel to one another and at a definable spacing (h) with respect to one another, providing a second layer (n+1) of powder, and fusing at least one part of the second layer (n+1) with second exposure vectors (Vn+1), which are arranged at an offset (x1, x2) parallel to the first exposure vectors (Vn), wherein the exposure vectors (Vn, Vn+1, Vn+2) of successive groups (G1, G2) are rotated by an angle (α) relative to one another.

In some embodiments, the spacing (h) is selected in such a way that webs (110, . . . , 330) formed by the fusion have an average overlap (w′) of at most 20%, preferably at most 10%.

In some embodiments, the spacing (h) is selected in such a way that the webs (Pn, Pn+1, Pn+2) formed by the fusion have an average overlap (w′) of 10% to −10%.

In some embodiments, the offset (x1, x2) corresponds at most to 50% of a width (w) of the webs (110, . . . , 330) produced by the fusion.

In some embodiments, the angle (α) is selected in such a way that the orientation of one of the following groups (G1, G2) corresponds to the original group again at the earliest after the fusion of 10 groups (G1, G2).

In some embodiments, the angle (α) is at least 30°, in particular at least 50°.

In some embodiments, the angle (α) is at most 150°, in particular at most 130°.

In some embodiments, the angle (α) is selected to be different from 90° or a multiple of 90°.

In some embodiments, the webs (110, . . . , 330) formed by the fusion penetrate at least the preceding layer (n, n+1, n+2), in particular the preceding three layers.

In some embodiments, at least one of the groups (G1, G2) comprises at least a third layer (n+2), wherein the second layer (n+1) is arranged offset by a first offset (x1) with respect to the first layer (n), and the third layer (n+2) is arranged offset by a second offset (x2) with respect to the second layer (n+1).

### BRIEF DESCRIPTION OF THE DRAWINGS

The teachings are described and explained in more detail below on the basis of the exemplary embodiments illustrated in the FIGURES. More specifically:

FIG. 1 schematically shows first exposure vectors in a powder bed with a first layer incorporating teachings of the present disclosure;

FIG. 2 shows webs of fused material of a first layer in cross section incorporating teachings of the present disclosure;

FIG. 3 schematically shows second exposure vectors in a powder bed which already has first and second webs of fused material incorporating teachings of the present disclosure;

FIG. 4 shows webs of fused material in a first and a second layer in cross section incorporating teachings of the present disclosure;

FIG. 5 shows webs of fused material in a first, second and third layer in cross section incorporating teachings of the present disclosure;

FIG. 6 schematically shows an angle between two layers incorporating teachings of the present disclosure; and

FIG. 7 shows a spacing between two exposure vectors and an overlap.

### DETAILED DESCRIPTION

Various embodiments of the teachings herein include a method for producing an object layer by layer using a powder-based 3D printing method by selective fusing of layers of a powder in a powder bed by means of a selective laser melting process or selective electron beam melting process. In each case at least two successive layers are combined to form a group. For each of the groups, the method comprises:
providing a first layer of the powder,
fusing at least one part of the first layer with first exposure vectors, which are arranged parallel to one another and at a definable spacing with respect to one another,
providing a second layer of powder, and
fusing at least one part of the second layer with second exposure vectors, which are arranged at an offset parallel to the first exposure vectors. The exposure vectors of successive groups are rotated by an angle relative to one another.

In other words, at least two successive layers are built up in a group, wherein, although the vectors within this group are arranged parallel to one another, they are offset with respect to one another. When the group is complete, the next group is rotated by an angle. It has been found that a considerable improvement in the tendency for overheating can be achieved by the combination of individual groups in which an offset is provided and by the rotation between the groups. It has likewise been possible to improve the mechanical properties of the object.

In some embodiments, the spacing between the exposure vectors is selected in such a way that webs formed by the fusion have an overlap, in particular an average overlap, of at most 20%, at most 10%, or in particular at most 5%. Here, the spacing between the vectors can be adjusted with high accuracy at the scanner. The overlap is determined in each case with reference to the web width. Here, the average overlap is the overlap which is established on average in one or more layers with a constant spacing between the exposure vectors. The web width results from the material used, the focus width of the energy beam used (e.g. laser beam) at the irradiation location in the powder bed and corresponding further parameters, such as the power of irradiation. These parameters are known for common plant-material pairs. The web width can furthermore be determined by tests for the material powder used and corresponding parameter variations of the plant used in each case. Here, for example, micrographs can be produced and an average web width and an average spacing between the fused webs can be determined therefrom.

It has been found that a relatively small overlap, which in itself would lead to an insufficient strength of the fused layers, in conjunction with the further layers, which have an offset, leads to a high strength while at the same time advantageously reducing the tendency for overheating.

In some embodiments, the spacing is selected in such a way that the webs formed by the fusion have an average overlap of 10% to −10%, in particular 5% to −5%. Here, the overlap can be achieved by adjusting the spacing between the exposure vectors at the scanner (at the control of the energy beam). Here, a negative overlap corresponds to a spacing between the webs corresponding to a proportion of the web width. In other words, the webs are on average arranged abutting one another. Thus, in this embodiment, there is no overlap, only a very small positive or a negative overlap. This can lead to individual webs not being completely welded to one another under certain circumstances. Accordingly, the subsequent layer within the group has the important task of achieving final welding.

In some embodiments, the offset corresponds at most to 50%, in particular 50%, of a width of webs produced by the fusion. If the offset corresponds on average to 50%, the webs of the second layer are arranged between the webs of the first layer and can thus achieve direct consolidation of the group. This increases the strength of the resulting group.

In some embodiments, the angle is selected in such a way that the orientation of one of the following groups corresponds to the original group again at the earliest after the fusion of 10 groups. The aim here is to ensure that, over as many layers as possible, the orientation does not once again correspond to the orientation of the first group, since in this way the effect of the reduced overheating is improved. Furthermore, the mechanical stability and, in particular, the isotropy of the mechanical properties of the object are improved if at least 5 groups are produced with different angular orientation from one another.

In some embodiments, the angle is at least 30°. In this way it can be ensured that the regions in which the energy beam repeatedly enters or exits from the surface to be produced differ sufficiently from group to group, thus further reducing a tendency to overheat at individual locations.

In some embodiments, the angle is at most 150°. In some embodiments, the angle is at most 130°. This has the effect that the regions in which the energy beam repeatedly enters or exits from the surface to be produced differ sufficiently from group to group. In this case, the regions are far apart in accordance with the angle, and therefore no overheating occurs here.

In some embodiments, the angle is selected to be different from 90° or multiples thereof. This ensures that the orientation does not already correspond to the original orientation again after just a few groups or a few layers. This ensures a high anisotropy of the resulting object and is furthermore advantageous as regards uniform heat input.

In some embodiments, the webs formed by the fusion penetrate at least the preceding layer. In some embodiments, the resulting webs penetrate the preceding three layers. In other words, the depth of the webs, that is to say the penetration depth into the underlying material or the underlying layers, also includes underlying layers in addition to the current layer. It has been found that, as a rule, the webs comprise at least two layers, but at most five layers, wherein the layer thickness in the fused state can correspond to 20-60 μm and the preceding unfused, doctored bulk thickness of the powder can correspond to 40 to 120 μm. The depth of the webs thus corresponds to a multiple of one layer thickness. Thus, the layers positioned by the offset interlock and there is an improvement in the structure.

In some embodiments, at least one of the groups comprises at least one third layer. In this case, the second layer is arranged at a first offset with respect to the first layer, and the third layer is arranged at a second offset with respect to the second layer. Here, the offsets can have the same value.

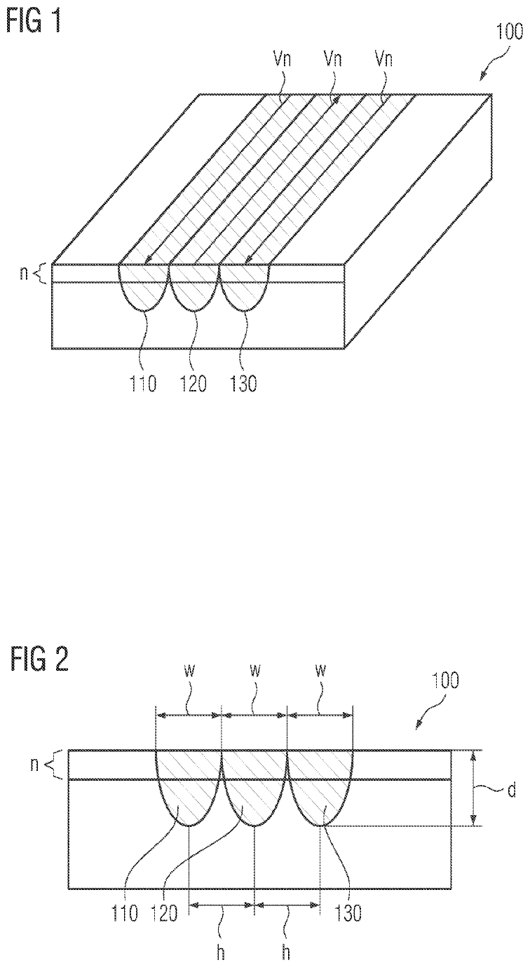

FIG. 1 schematically shows first exposure vectors Vn in a powder bed 100 with a first layer n. The first exposure vectors VN result in the formation of already fused webs 110, 120, 130. In this case, the exposure vectors VN are arranged parallel to one another and are provided by an energy beam, e.g. a laser or an electron beam. In this context, the exposure vectors include the speed, the power and the beam width of the energy beam. Here, the existing webs 110, 120, 130 are only representative of a very large number of welded webs which are produced in the context of an additive manufacturing process. As a rule, a number of webs significantly greater than three is required to produce one layer of an object. For the sake of clarity, only a small number are selected below in order to be able to illustrate the relationships between the individual webs 110, 120, 130 in a comprehensible manner.

FIG. 2 shows the webs 110, 120, 130 of fused material of the first layer n from FIG. 1 in cross section. Here, the webs 110, 120, 130 of fused material in the first layer n have a width w and a spacing h, also referred to as a hatch spacing. The spacing h is measured starting from the exposure vectors or from the center of the fused webs 110, 120, 130 produced by the exposure. In the present example, the three webs 110, 120, 130 have a spacing h which is selected in such a way that it corresponds to the width w of the webs 110, 120, 130. That is, the webs 110, 120, 130 touch at the outer end. In the present example in FIG. 2, an overlap does not exist or only exists to the extent of the tolerance of the respective process used.

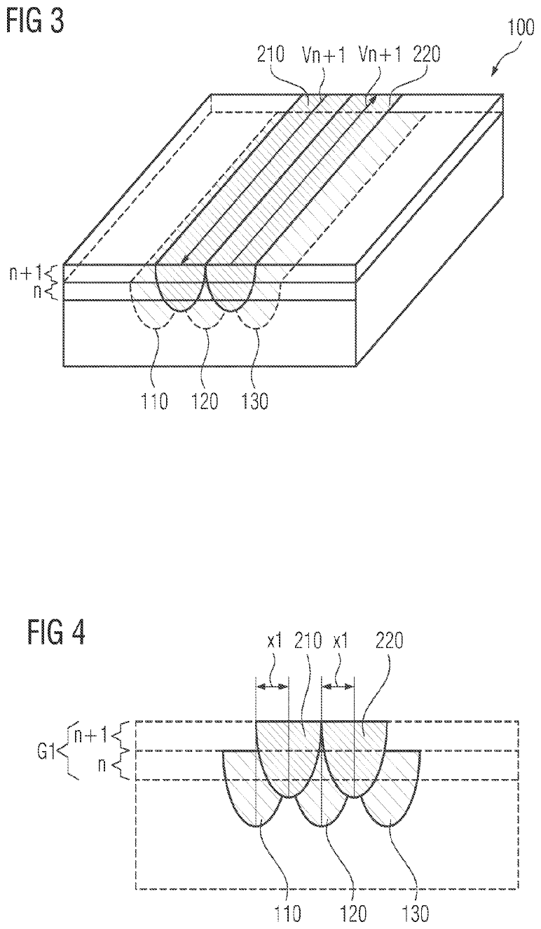

FIG. 3 schematically shows second exposure vectors Vn+1 in a powder bed 100 which already has first and second webs 110, 120, 130, 210, 220 of fused material. In this case, the first webs 110, 120, 130 have been formed by exposure of the first layer n, and the second webs 210, 220 have similarly been formed by exposure of the second layer n+1 to the second exposure vectors Vn+1. Here too, only two webs 210, 220 are shown in the second layer n+1, while in reality the second layer n+1 is also made up of significantly more webs in accordance with the object geometry to be produced. The simplification of the present example serves for improved illustration of the principle.

In this case, the second exposure vectors Vn+1 are arranged parallel to and displaced by an offset with respect to the first exposure vectors (not illustrated here).

FIG. 4 shows webs 110, 120, 130, 210, 220 of fused material in a first and a second layer n, n+1 in cross section, wherein an offset x1 is depicted. Here, the offset x1 is determined from center line to center line of the webs, in the present case the center line of web 110 to the center line of web 210 and the center line of web 120 to the center line of web 220. In this case, the center line is also the location at which the exposure vectors Vn, Vn+1 impinge. Furthermore, it can be seen that the first layer n and the second layer n+1 are combined in a first group G1. Accordingly, the webs 110, 120, 130, 210, 220 are arranged parallel to one another within the first group G1. A second group G2, not yet shown here, would have a changed orientation with respect to the first group. This leads to a further improvement in the temperature distribution while avoiding overheating.

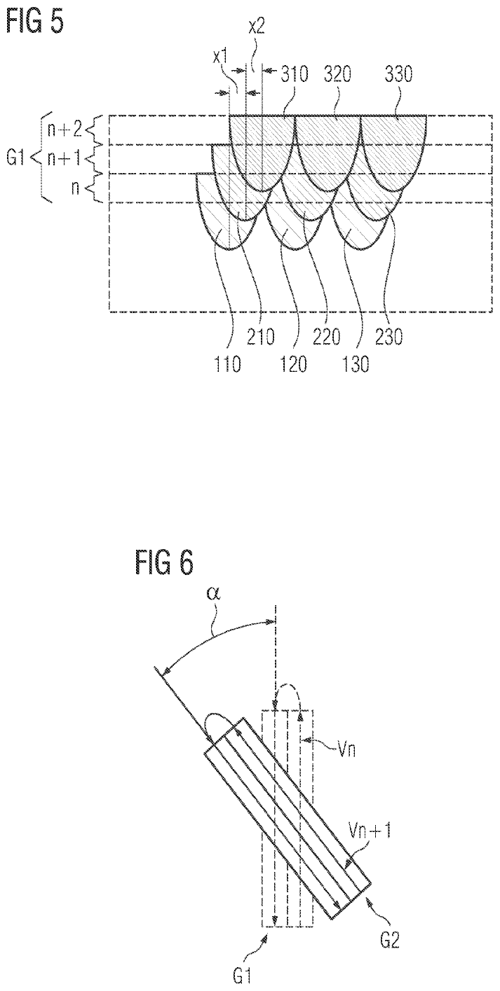

FIG. 5 shows webs 110, 120, 130, 210, 220, 230, 310, 320, 330 of fused material in a first, second and third layer n, n+1, n+2 in cross section. Also depicted are a first offset x1 and a second offset x2, wherein the first offset x1 represents the offset of the exposure vectors of the first layer n with respect to the second layer n+1 and, similarly, the second offset x2 represents the offset of the exposure vectors of the second layer n+1 with respect to the third layer n+2. Accordingly, the offsets also correspond to the offset of the actually fused webs 110, 120, 130, 210, 220, 230, 310, 320, 330 with respect to one another. Here, the first, second and third layers n, n+1, n+2 are again grouped into a group G1 and accordingly have the same orientation.

FIG. 6 schematically shows an angle α between two groups G1 and G2. Successive groups G1, G2 are rotated relative to one another. This means that the exposure vectors Vn of the first group G1 are at an angle α to the exposure vectors Vn+1 of the second group G2. Since the exposure vectors and the resulting fused webs are parallel to one another within the groups, the angle for the exposure vectors in one group applies with respect to the exposure vectors of the following group. It has been found that 67 degrees is a good compromise between rare repetitions of angles and uniform temperature distribution across groups.

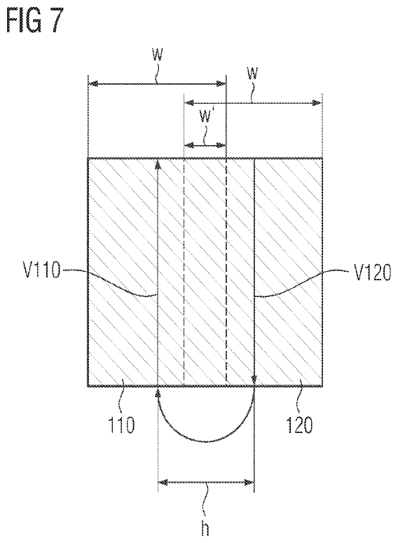

FIG. 7 shows a first web 110 and a second web 120 with their exposure vectors V110, V120. The webs 110, 120 each have a width w and a spacing h with respect to one another. Furthermore, the webs 110, 120 overlap because the spacing h is selected to be smaller than the width w of the webs 110, 120. The region in which the webs 110, 120 overlap is designated as an overlap w′. The overlap can vary slightly depending on the process used and its web accuracy. Here, the overlap can be on average +/−0%, i.e. the webs are arranged on average so as to abut.

In summary, the teachings of the present disclosure include methods and/or systems for producing an object layer-by-layer using a powder-based 3D printing method by selective fusing of layers (n, n+1, n+2) of a powder in a powder bed (100). To avoid local overheating in selective, powder-based 3D printing methods, at least two successive layers (n, n+1, n+2) are combined to form a group (G1, G2) in each case. The method also comprises the following steps for each of the groups (G1, G2):
providing a first layer (n) of the powder,
fusing at least one part of the first layer (n) with first exposure vectors (Vn), which are arranged parallel to one another and at a definable spacing (h) with respect to one another,
providing a second layer (n+1) of powder,
fusing at least one part of the second layer (n+1) with second exposure vectors (Vn+1), which are arranged at an offset (x1, x2) parallel to the first exposure vectors (Vn),
wherein the exposure vectors (Vn, Vn+1, Vn+2) of successive groups (G1, G2) are rotated by an angle (α) relative to one another.

Reference symbols

| | |
|---|---|
| 100 | powder bed |
| n, n + 1, n + 2 | layers |
| V1, V2, V3 | exposure vectors |
| h | spacing of the exposure vectors |
| 110, 120, 130 | webs of fused material in a first layer |
| 210, 220, 230 | webs of fused material in a second layer |
| 310, 320, 330 | webs of fused material in a third layer |
| w | width of the webs |
| w′ | overlap of the webs |
| d | depth of the webs |
| G1 | first group of layers |
| G2 | second group of layers |
| x1 | first offset |
| x2 | second offset |
| α | angle between the groups |

What is claimed is:

1. A method for producing an object layer-by-layer using a powder-based 3D printing method by selective fusing of layers of a powder in a powder bed with a selective laser melting process or selective electron beam melting process, wherein at least two successive layers are part of a group, the method comprising, for each:
providing a first layer of the powder;
fusing at least one part of the first layer with first exposure vectors arranged parallel to one another and at a defined spacing with respect to one another;
providing a second layer of powder; and
fusing at least one part of the second layer with second exposure vectors arranged at an offset parallel to the first exposure vectors;
wherein the exposure vectors of successive groups are rotated by an angle relative to one another.

2. The method as claimed in claim 1, wherein webs formed by fusion have an average overlap of at most 20%.

3. The method as claimed in claim 1, wherein the webs formed by fusion have an average overlap of 10% to −10%.

4. The method as claimed in claim 1, wherein the offset corresponds at most to 50% of a width of the webs produced by fusion.

5. The method as claimed in claim 1, wherein the orientation of one of the following groups corresponds to the original group again at the earliest after the fusion of 10 groups.

6. The method as claimed in claim 1, wherein the angle is at least 30°.

7. The method as claimed in claim 1, wherein the angle is at most 150°.

8. The method as claimed in claim 1, wherein the angle is not 90° or an integer multiple of 90°.

9. The method as claimed in claim 1, wherein the webs formed by fusion penetrate at least the preceding layer.

10. The method as claimed in claim 1, wherein:
one of the groups comprises a third layer;
the second layer is offset by a first offset with respect to the first layer; and
the third layer is arranged offset by a second offset with respect to the second layer.
